(19) United States
(12) Patent Application Publication
(10) Pub. No.: US 2009/0014189 A1
(43) Pub. Date: Jan. 15, 2009

(54) APPARATUS AND METHODS FOR LAND PREPARATION AND CLEARING

(75) Inventors: Jeffrey Stanley, Lebanon, OH (US); Robert Hentz, Hamilton, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: FECON, INC., Lebanon, OH (US)

(21) Appl. No.: 12/171,784

(22) Filed: Jul. 11, 2008

Related U.S. Application Data
(60) Provisional application No. 60/949,712, filed on Jul. 13, 2007.

(51) Int. Cl. A01B 35/28

(52) U.S. Cl. 172/109; 172/292; 172/554; 172/550

(57) ABSTRACT

Embodiments of the present apparatus comprise a land preparation apparatus that includes a rotatable drum, a plurality of tool holders arranged on the drum, wherein each tool holder comprises a first connection interface, a plurality of land preparation tools, wherein each land preparation tool is configured to connect with a tool holder and wherein each land preparation tool comprises a second connection interface, a plurality of removable connectors, wherein the connectors comprise a material different from that of the tool holders and the land preparation tools, wherein each connector is removable from the tool and the tool holder, and wherein each connector is configured to mate with a first connection interface of a tool holder and with a second connection interface of a land preparation tool. The apparatus further includes a land preparation vehicle comprising an attachment connection device configured to mate with the rotatable drum, wherein the vehicle is configured to drive the rotatable drum.

### CROSS REFERENCE TO RELATED APPLICATIONS

This application claims benefit to the Provisional Application Ser. No. 60/949,712 filed Jul. 13, 2007.

### TECHNICAL FIELD

The present invention relates to attachment systems and methods for land preparation tools, such as cutting, grinding, mulching, and/or shredding tools, more particularly tool interfaces for attachments to powered vehicles.

### BACKGROUND

Land preparation and clearing machines and apparatus such as forestry machines and apparatus are utilized for clearing land, creating paths, and otherwise removing debris, brush, trees, vegetation, soil, concrete, asphalt, rock, and/or other materials, making the land suitable for further development or use. To carry out these tasks, such machines can be fitted with land preparation attachments or apparatus operable to mulch, cut, shred, and/or grind vegetation, brush, trees, stumps, soil, concrete, asphalt, rock, and other materials.

In particular, the apparatus may be integrally or detachably attached to a tractor, skid steer, or other vehicle to facilitate articulation and movement of the mowing apparatus with respect to the vegetation. Often, the vehicle is a multi-purpose vehicle having the capability to be fitted with any of a variety of attachments suitable for the task at hand. For example, the vehicle can include a common connection for connecting to and driving the apparatus such as brush cutters, rotary mowers, shredders, grinders, and crushers. Such land preparation and clearing apparatus can be hydraulically driven via hydraulic power from the vehicle. One illustrative type of land preparation and clearing apparatus is known as a “flail mower” which utilizes a rotatable axle with either swinging or fixed position cutting tools (often known as “flails”).

### SUMMARY

According to one exemplary embodiment, a land preparation apparatus comprises a rotatable drum, a plurality of tool holders arranged on the drum, wherein each tool holder comprises a first connection interface, a plurality of land preparation tools, wherein each land preparation tool is configured to connect with a tool holder and wherein each land preparation tool comprises a second connection interface, a plurality of removable connectors, wherein the connectors comprise a material different from that of the tool holders and the land preparation tools, wherein each connector is removable from the tool and the tool holder, and wherein each connector is configured to mate with a first connection interface of a tool holder and with a second connection interface of a land preparation tool.

According to another exemplary embodiment, the land preparation apparatus comprises at least one of a first connection interface and a second connection interface, wherein each first connection interface comprises a round recess in the tool holder, wherein each second connection interface comprises a round recess in the land preparation tool, and wherein each connector comprises a round peg configured to fit within the recesses.

According to another exemplary embodiment, the apparatus comprises a peg that is hollow. According to another exemplary embodiment, the apparatus comprises a channel extending from the rear of the tool holder to the round recess in the tool holder, wherein each tool comprises a threaded channel adjacent the round recess of the tool, and further comprising a bolt extending through the channel and the hollow peg, and into the threaded channel, the bolt including threads engaging threads in the threaded channel and holding the tool to the tool holder with the peg extending between the tool and the tool holder.

According to another exemplary embodiment, the connector comprises a carbide or mild steel material.

According to yet another exemplary embodiment, the apparatus may further comprise a land preparation vehicle comprising an attachment connection device configured to mate with the rotatable drum, wherein the vehicle is configured to drive the rotatable drum, and to still a further exemplary embodiment, the vehicle is configured to drive the rotatable drum by hydraulic power.

According to still another exemplary embodiment, a Land Preparation Machine comprises a driver station, an all-terrain wheel assembly, a rotatable drum, controls for controlling the wheel assembly and the drum, a plurality of tool holders arranged on the drum, wherein each tool holder comprises a pilot hole, a plurality of land preparation tools, wherein each land preparation tool is configured to connect with a tool holder and wherein each land preparation tool comprises a second pilot hole, a plurality of centering rings, wherein the ring comprise a material different from that of the tool holders and the land preparation tools, wherein each ring is removable from the tool and the tool holder, and wherein each ring is located in the first and second pilot holes and to extends between a tool holder and a land preparation tool, and a plurality of bolts, each bolt extending through the pilot hold of a tool holder, through a centering ring, and through the pilot hole of a tool, each bolt holding together a tool holder, a centering ring, and a tool.

According to still yet another exemplary embodiment, an apparatus comprises a support configured to be driven by a Land Preparation Machine, a tool holder held on the support, a forestry tool configured to connect with the tool holder, a connector removable from the tool and the tool holder and provided between the tool holder and the tool.

According to still yet a further exemplary embodiment, an apparatus comprises a support configured to be driven by a Land Preparation Machine, a tool holder held on the support, a land preparation tool configured to connect with the tool holder, a removable connector interfacing the tool holder and the tool.

These and additional objects and advantages provided by the embodiments of the present invention will be more fully understood in view of the following detailed description, in conjunction with the drawings.

### BRIEF DESCRIPTION OF DRAWINGS

The following detailed description of embodiments of the present invention can be best understood when read in conjunction with the drawings enclosed herewith:

FIG. 1 is a top perspective view of an exemplary land preparation and clearing machine according to one or more embodiments of the present invention;

FIG. 2 is a perspective view of the exemplary land preparation and clearing machine of FIG. 1;

FIG. 3 is a a schematic view of an exemplary rotatable tool which utilizes a double mating arrangement to couple the land preparation tool to the tool holder according to one or more embodiments of the present invention;

FIG. 4a is a side view photograph illustrating an exemplary tool holder, connector, and land preparation tool of the land preparation apparatus, which may be coupled via a double mating arrangement, according to one or more embodiments of the present invention;

FIG. 4b is a photograph illustrating an exemplary double mating arrangement like FIG. 4a, but with the tool holder rotated so that the front side may be viewed according to one or more embodiments of the present invention;

FIG. 5 is a schematic view of an exemplary rotatable tool which utilizes a single mating arrangement to couple the land preparation tool to the tool holder according to one or more embodiments of the present invention;

FIG. 6a is a side view photograph illustrating an exemplary land preparation tool, which may be used in a single mating arrangement, according to one or more embodiments of the present invention;

FIG. 6b is a photograph illustrating an exemplary land preparation tool like in FIG. 4a, but with the tool holder rotated so that the front side may be viewed according to one or more embodiments of the present invention;

FIG. 7 is a cross-sectional view illustrating an exemplary coupling of the land preparation tool to the tool holder via a double bolting arrangement according to one or more embodiments of the present invention; and

FIG. 8 is a cross-sectional view illustrating an exemplary coupling of the land preparation tool to the tool holder via a single bolting arrangement according to one or more embodiments of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF ILLUSTRATIVE EMBODIMENTS

The present invention is generally directed to land preparation and clearing machines (“Land Preparation Machine”) that are designed to cut, grind, mulch, shred clear, mill, and/or mix trees, brush, ground cover, vegetation, debris, asphalt, concrete, and/or soil. The Land Preparation Machines and their corresponding implements may comprise a variety of vehicles and implements, including but not limited to skid steer vehicles, forestry machines and vehicles, PTO tractors, farm tractors and/or any other known vehicles and their corresponding implements compatible with land preparation and clearing. Such Land Preparation Machines may prepare the surface of the earth and are not sub-surface machines used in mining operations. As used herein, the phrases “land preparation and clearing” and ““land preparation” will mean any land preparation and clearing operations, including but not limited to forestry operations such as cutting, grinding, mulching, shredding, clearing, milling, and/or mixing trees, brush, ground cover, vegetation, debris, soil, rock, asphalt, concrete, and/or soil. However, such phrases do not mean any subsurface work such as mining, drilling, etc. As used herein, “feed material” describes trees, brush, ground cover, vegetation, debris, soil, rock, asphalt, concrete, and/or soil produced from such land preparation and clearing operations, including but not limited to forestry operations such as clearing land, cutting and/or mulching trees, and/or preparing land surfaces (e.g., creating paths).

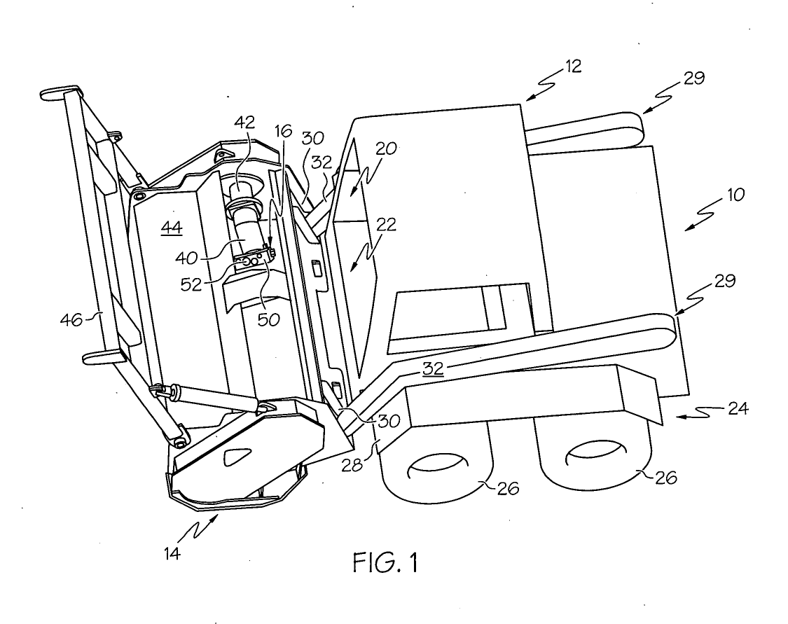

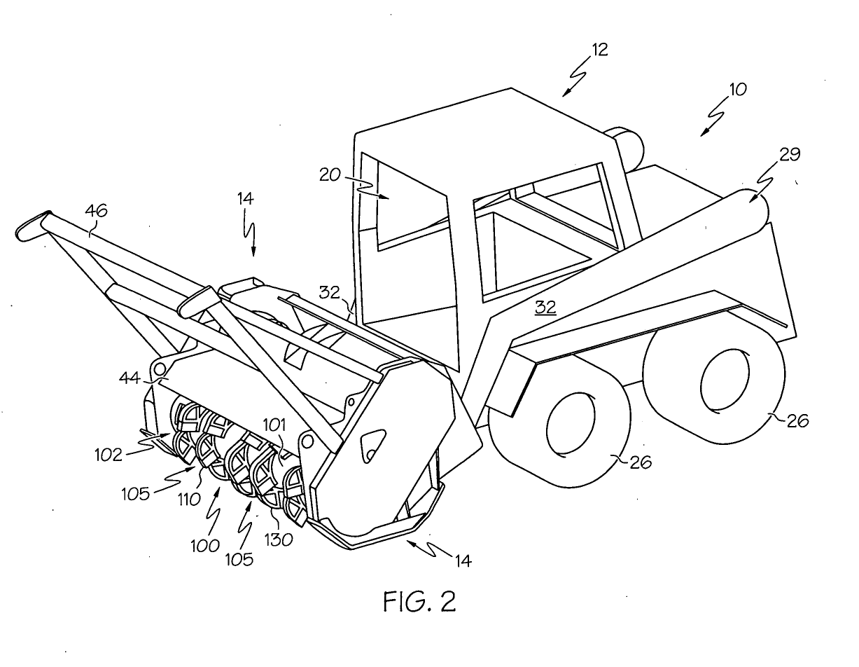

Referring to FIGS. 1-2, an exemplary embodiment of a Land Preparation Machine 10, including a vehicle 12 (e.g., a forestry vehicle) and a land preparation apparatus 14 connected to the vehicle 12, is shown. In this exemplary embodiment, the vehicle 12 is a skid steer vehicle suitable for off-road travel, and includes a driver station 20 as well as an all-terrain wheel assembly 24. The wheel assembly may include tires 26. In addition, tires 26 may drive all-terrain tracks (not shown), which may provide traction for the vehicle 12 to move over a variety of terrains and in a variety of conditions. The all terrain tracks may comprise metal or rubber-based tracks that wrap around tires 26 as known to one of ordinary skill in the art. The vehicle 12 also includes a hydraulically operated vertical lift assembly 29 for vertically lifting the land preparation apparatus 14, and any other attachments that may be used with the vehicle. Controls 22 can be provided for control of the hydraulic lift assembly 29, including the lift arms 32 as well as for controlling the power provided to the wheel assembly 24 and for controlling the operation of the land preparation apparatus 14.

While the land preparation apparatus 14 is shown in this example connected to and powered by vehicle 12 which is a skid steer vehicle, other suitable all-terrain vehicles with capability for powering and utilizing a hydraulic motor attachment or tool (e.g., such as land preparation apparatus 14) could be provided, such as other forestry vehicles, mini-track loaders, excavators, backhoes, PTO tractors, farm tractors, and/or any other known vehicles and their corresponding implements compatible with land preparation and clearing. Further examples of suitable skid steer vehicles are shown and described in U.S. Pat. Nos. 4,168,757 and 4,209,071, the entire disclosures of which are hereby incorporated by reference herein.

In the exemplary embodiment shown in FIGS. 1 and 2, the land preparation apparatus 14 is removably connectable to the vehicle 12. The connection between the attachment 14 and the vehicle 12 can be accomplished in any of a variety of manners, such as by providing receptacles 30 for receiving vertical lift arms 32 from the vehicle 12. The land preparation apparatus 14, in this example, further includes a hydraulic supply connection for receiving an operating supply of hydraulic fluid from a pump within the vehicle to power the land preparation apparatus 14, and a hydraulic return connection for returning hydraulic fluid to a tank within the vehicle 12. The hydraulic supply and return connections may comprise convention quick-disconnect connections as known to one of ordinary skill in the art.

It is understood that land preparation apparatus 14 may also be fixedly attached to the vehicle 12 and/or be a stand alone machine such as a walk behind land preparation apparatus. Also, it is understood that other hydraulically-operated rotary mowing or cutting attachments may be utilized with principles of the present invention, integral with or detachable from vehicle 12, and/or separately from or in combination with the land preparation apparatus 14. Other configurations are also possible, such as where the fluid pump and tank are located at other locations. Connection, powering, and movement of the land preparation apparatus 14 can be accomplished with various configurations, such as those described in U.S. Pat. Nos. 4,148,366, and 5,813,792, for example, which are hereby incorporated herein by reference.

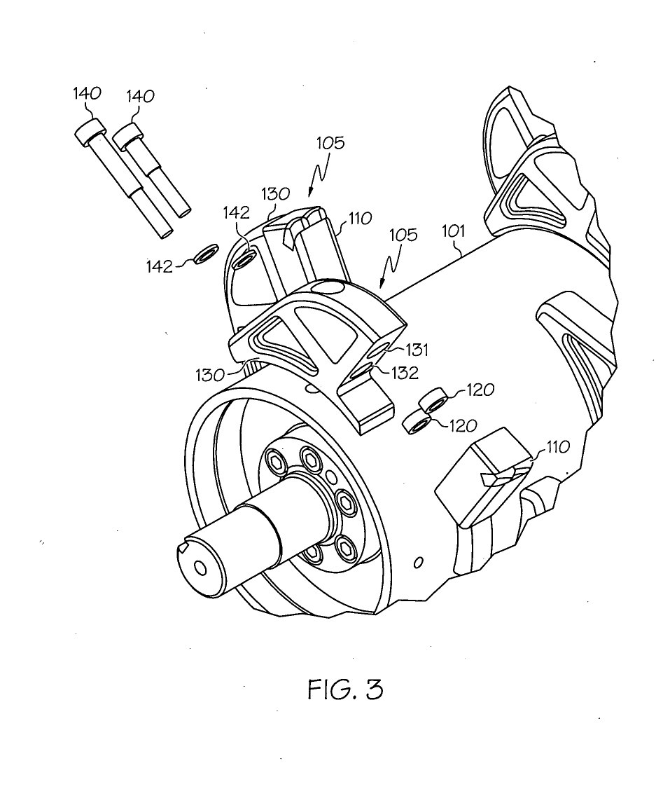

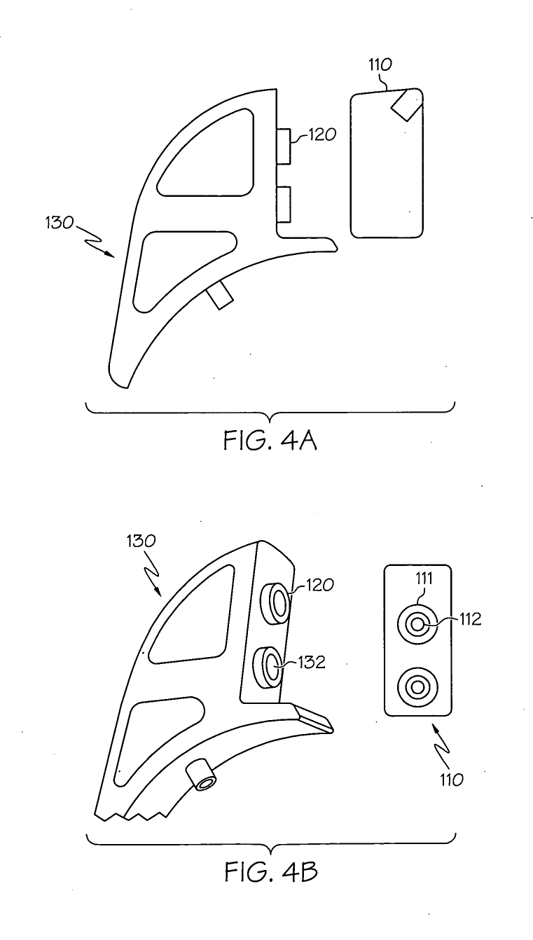

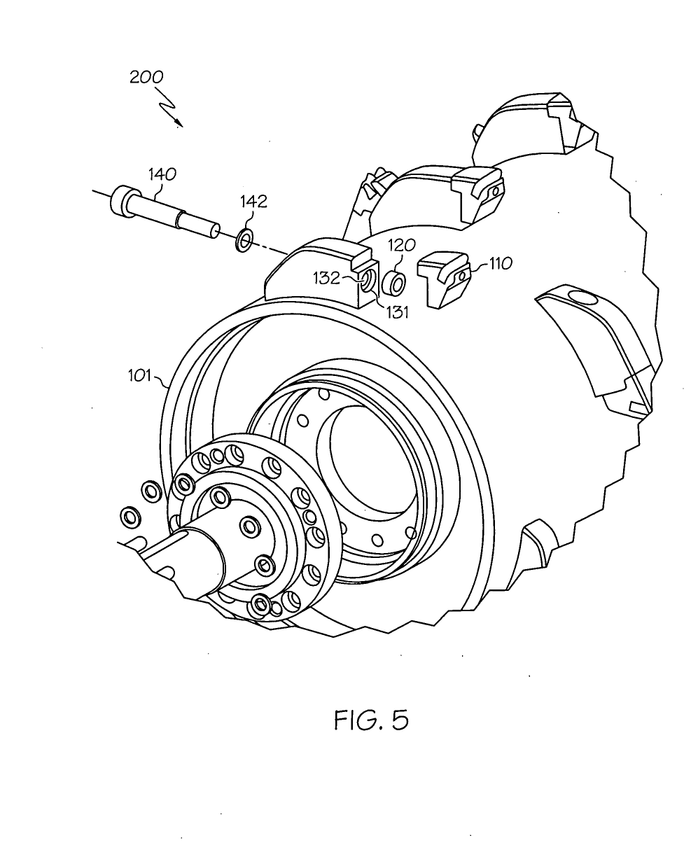

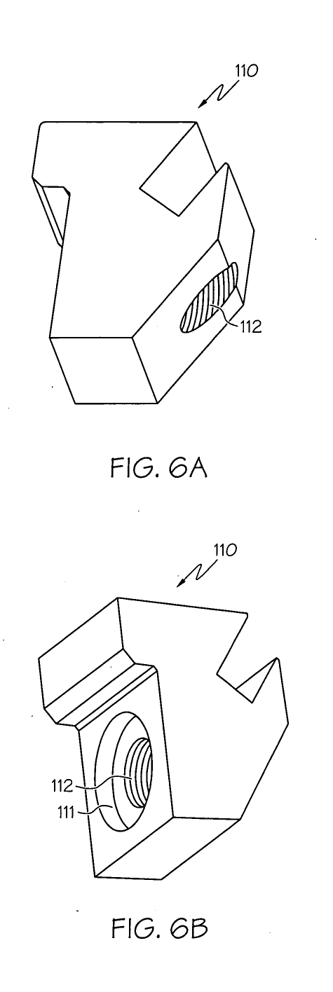

Referring to FIGS. 1-8, the land preparation apparatus 14 may include a housing 44 forming a chamber 102, right and left end plates 105 and 107, respectively, connected to the housing 44, and a movable tool (e.g., rotatable tool 100) movably (e.g., rotatably) connected to and between the right and left end plates 105 and 107 within the chamber 102. Right and left end plates 105 and 107 may alternatively be integral with the housing 44. In this exemplary embodiment, the rotatable tool 100 comprises a rotatable drum or rod 101 and at least one tool element 105 positioned on the rotatable drum 101. The exemplary rotatable tool 100 shown in FIG. 2 comprises a plurality of tool elements 105 spaced along and extending radially from the tool drum 101. FIGS. 3 and 4 show greater detail of the rotatable tool 100 and its components, and will be described in detail below herein. FIGS. 5 and 6 shown an alternative exemplary embodiment of a rotatable tool 200 of the present invention. As such, the rotatable tool 200 may also be movably connected or mounted within the chamber 102 of the land preparation apparatus 14, thereby being operable with the Land Preparation Machine 10.

Optionally, rotatable tool 100 (and rotatable tool 200) may also comprise an axle (not shown) extending longitudinally from either one or both ends of the tool drum 101. For movement of the rotatable tool 100 (and rotatable tool 200), a hydraulic motor 40, such as a hydraulic piston motor, provides rotation of a rotor (e.g., drive shaft 42) which drives the rotatable tool drum 101, which thereby causes rapid rotation of the tool elements 105, such as at speeds of between about 100 to about 3000 rpm. The drive shaft 42 may drive a belt (not shown), which engages and drives the axle (not shown) to turn tool drum 101. Alternatively, the drive shaft 42 may be directly connected to the tool drum 101 or axle. It is understood that the movable tool (e.g., rotatable tool 100) of the land preparation apparatus 14 may be operated and/or driven by non-hydraulic means such as electric, and/or gasoline powered motors to cause mulching action, such as described above. Although the present apparatus has been discussed in view of mulching, it is contemplated that the present apparatus would be suitable for other applications, for example, stump grinding.

In one particular embodiment, the hydraulic lift arms 32 raise and lower the land preparation apparatus 14 via controls 22 to allow the rotatable tool's rotating tool elements 105 (e.g., teeth or cutters) to come into contact with brush, trees, vegetation, or other objects to be cut or shredded or cleared. Controls 22 may also control the supply of fluid to the hydraulic motor 40 to start and stop the rotation of the tool drum 101 and tool elements 105.

In yet another exemplary embodiment, the hydraulic motor 40 is controlled by a hydraulic brake 16 which automatically slows the motor 40 when the flow of hydraulic fluid to the motor via the hydraulic supply line is discontinued. For additional detail on land preparation machinery (e.g., forestry machinery) or hydraulic components associated with land preparation machinery (e.g., forestry machinery), U.S. Publication No. 2006/0032222 has been incorporated by reference in its entirety herein.

Referring to FIGS. 2-6, the rotatable tool 100 (and rotatable tool 200), including the tool drum 101 and tool elements 105, may be formed in any of a number of suitable configurations, including but not limited to a plurality of spaced tool elements 105 disposed on one or more tool drums (not shown) which may be mounted between end plates 105 and 107 of the land preparation apparatus 14. Specifically, each tool element may comprise a tool holder 130 extending radially from the tool drum 101 and disposed longitudinally along and circumferentially about the tool drum 101. The tool holders 130 may be fixedly, removably, and/or rotatably mounted to tool drum 101. The tool holders 130 comprises a land preparation tool 110.

As used herein, the term “land preparation tool” includes, but is not limited to a cutter, blade, grinder, chipper, knife, hammer tool, milling tool, flailing tool or element, carbide tip, steel tip, composite tip, any other tool for suitable for land surface preparation and clearing as described and defined above herein, or any combination thereof. The land preparation tool 110 may be fixedly or removably connected to or integral with the tool holder 130. If removable, the land preparation tool 110 may be a replaceable tip that is designed to be replaced once worn due to use, permitting the tool holder 130 to remain affixed to the tool drum 101 while the tool 110 is replaced. The tool elements 105, and any of its components, may be fabricated from a variety of metals, composites, plastics, or combinations thereof. Exemplary tool elements that may comprise the present invention include those tool elements described in U.S. Pat. No. 4,223,441 and U.S. Pat. No. 4,222,418, which are hereby incorporated by reference herein.

Each tool holder 130 may also comprise a first connection interface 131. The first connection interface 131 defines a round recess region disposed in the tool holder 130 as shown in FIGS. 3 and 5. Specifically referring to FIG. 4b, the land preparation tool 110 may comprise a second connection interface 111. Like the tool holder 130, the second connection interface 111 may comprise a round recess region disposed on the land preparation tool. In the embodiment of FIG. 4b, the land preparation tool 110 may comprise two rounded recess regions 111 disposed on the land preparation tool 110. The first 131 and second 111 interfaces may comprise various dimensions.

The mulching apparatus 100 may also comprise at least one connector 120 configured to mate with the first connection interface 131 of the tool holder 130 as well as the second connection interface 111 of the land preparation tool 110. In one embodiment, the connector 120 is a rounded peg, for example, a hollow rounded peg, configured to fit within the rounded recess regions 111 and 131 of the land preparation tool 110 and tool holder 130, respectively. In a further embodiment, the connector 120 is removable. Due to the wear and tear on the connector from the rotation of the drum and the mulching action performed, it has been found beneficial to have a removable connector, so that the connector may be easily replaced. Moreover, it is contemplated that the connector 120 may comprise a different material than the land preparation tool 110 or the tool holder 130. The connector 120 may comprise a carbide, mild steel, or other materials, such as metals, and durable organic and inorganic compositions as would be familiar to one of ordinary skill in the art. The connectors 120 may have varying shapes and dimensions. In operation, the rounded peg 120 is operable to join the land preparation tool 110 and the tool holder 130 by press fitting, slip fitting, etc. The peg 120 may fit within the interface recesses 131 and 111 and abut support surfaces defining the end of the recesses. Accordingly, the land preparation tool 110 described above can compress the tool holder 130 and the connector 120.

The connector 120 provides numerous benefits to this apparatus. Although, it is not required. For example, the connector 120 protects against tool holder 130 wear while acting as a structural support for tool positioning and lateral loading. The connector 120 may also improve fastening between the tool holder 130 and land preparation tool 110. As stated above, the connector 120 has a unique design and removability that enables it to be manufactured out of materials different from the tool holder 130 or land preparation tool 110. By altering the material properties of the connector 120 material, component wear can be controlled and an increased level of tolerance may be provided with minimal cost to the system.

In addition to the mating connection of the tool holder 130 to the land preparation tool 110 provided by the connector 120, it may be desirable to have an extra securing mechanism. As shown in FIGS. 3-6, the mulching apparatus 100 or 200 may utilize one or more securing bolts 140 extending through the land preparation tool 110, tool holder 130, and/or connector 120. The land preparation tool 110, the connector 120, and the tool holder 130 may all comprise channels or apertures for the securing bolt 140(s) to extend therethrough. In the embodiments of FIG. 4a and 4b, the land preparation tool 110 may comprises two channels 112 disposed inside the two respective recess regions 111. The land preparation tool 110 comprises a channel 112 disposed inside the rounded recess region 111 of the land preparation tool 110 as shown in FIGS. 6a and 6b.

Referring to FIGS. 3, 4b, and 5, the tool holder 130 may comprise a channel 132, which is disposed inside the round recessed region 131. The respective channels of the land preparation tool 110, the tool holder 130, and/or the connector 120 may comprise internal threads configured to engage the external threads of the securing bolts 140. A locking washer 142, locking pin or other suitable mechanism may be used to ensure the securing bolt(s) 140 is firmly secure within the channels of the land preparation tool 110, the tool holder 130, and/or the connector 120.

During assembly as shown generally in the embodiments of FIGS. 3a-8, the tool holder 130 is mounted to a drum 101 by a suitable mounting mechanism, for example, through a bolt, screw, or weld. The connector 120 may then be inserted into the recessed region 131 of the tool holder 130, and then tool holder 110 is coupled to the land preparation tool 110 by inserting the connector 120 into the recessed region 111 of the land preparation tool 110. The connector 120 resides within the land preparation tool 110 and the tool holder 130, after these two components are connected to one another. Subsequently, the bolts 140 (or single bolt 140 in exemplary embodiment of FIGS. 5 and 6) are inserted through tool holder 130, land preparation tool 110 and connector to secure the apparatus. The bolt may comprise external threads which engage with the internal threads of components 110, 120, and 130. A locker washer 142 may further be used to secure the bolt 140 in place.

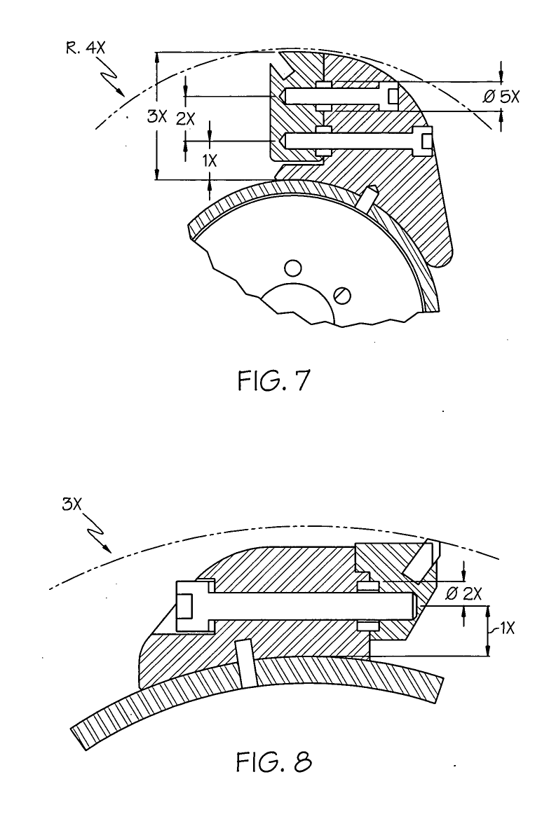

FIG. 7 shows a cross-sectional view of the coupling of the land preparation tool 110 to the tool holder 130 via a double bolting arrangement (two bolts 140). In one exemplary embodiment, dimension 1× may comprise from about 1.0 to about 2.0, or from about 1.3 to about 1.4; dimension 2× may comprise from about 1.2 to about 2.4, or from about 1.6 to about 1.9; and dimension 5× may comprise from about 0.5 to about 1.5, from about 0.9 to about 1.2, from about 1.06 to about 1.07, or about 1.0625.

FIG. 8 shows a cross-sectional view of the coupling of the land preparation tool 110 to the tool holder 130 via a single bolting arrangement (e.g., bolt 140). In one exemplary embodiment, dimension 1× may comprise from about 1.0 to about 2.0, or from about 1.2 to about 1.8; dimension 2× may comprise from about 0.5 to about 2.5, from about 1.1 to about 2.0; from about 1.0 to about 1.5, or about 1.25.

Although the embodiments of the present invention are directed to only one or two bolt assemblies, it is contemplated that more bolts may be used for connecting the land preparation tool 110 to the tool holder 130. It is noted that terms like “specifically,” “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A land preparation apparatus, comprising:
a rotatable drum;
a plurality of tool holders arranged on the drum, wherein each tool holder comprises a first connection interface;
a plurality of land preparation tools, wherein each land preparation tool is configured to connect with a tool holder and wherein each land preparation tool comprises a second connection interface;
a plurality of removable connectors, wherein the connectors comprise a material different from that of the tool holders and the land preparation tools, wherein each connector is removable from the tool and the tool holder, and wherein each connector is configured to mate with a first connection interface of a tool holder and with a second connection interface of a land preparation tool.

2. The apparatus as recited in claim 1, wherein each first connection interface comprises a round recess in the tool holder, wherein each second connection interface comprises a round recess in the land preparation tool, and wherein each connector comprises a round peg configured to fit within the recesses.

3. The apparatus as recited in claim 2, wherein the peg is hollow.

4. The apparatus as recited in claim 3, wherein each tool holder comprises a channel extending from the rear of the tool holder to the round recess in the tool holder, wherein each tool comprises a threaded channel adjacent the round recess of the tool, and further comprising
a bolt extending through the channel and the hollow peg, and into the threaded channel, the bolt including threads engaging threads in the threaded channel and holding the tool to the tool holder with the peg extending between the tool and the tool holder.

5. The apparatus as recited in claim 1, wherein the connector comprises a carbide or mild steel material.

6. The apparatus as recited in claim 1, further comprising:
a land preparation vehicle comprising an attachment connection device configured to mate with the rotatable drum, wherein the vehicle is configured to drive the rotatable drum.

7. The apparatus as recited in claim 6, wherein the vehicle is configured to drive the rotatable drum by hydraulic power.

8. A Land Preparation Machine, comprising:
a driver station;
an all-terrain wheel assembly;
a rotatable drum;
controls for controlling the wheel assembly and the drum;
a plurality of tool holders arranged on the drum, wherein each tool holder comprises a pilot hole;
a plurality of land preparation tools, wherein each land preparation tool is configured to connect with a tool holder and wherein each land preparation tool comprises a second pilot hole;
a plurality of centering rings, wherein the ring comprise a material different from that of the tool holders and the land preparation tools, wherein each ring is removable from the tool and the tool holder, and wherein each ring is located in the first and second pilot holes and to extends between a tool holder and a land preparation tool; and
a plurality of bolts, each bolt extending through the pilot hold of a tool holder, through a centering ring, and through the pilot hole of a tool, each bolt holding together a tool holder, a centering ring, and a tool.

9. An apparatus, comprising:
a support configured to be driven by a Land Preparation Machine;
a tool holder held on the support;
a land preparation tool configured to connect with the tool holder;
a removable connector interfacing the tool holder and the tool.
